(19) United States
(12) Patent Application Publication
(10) Pub. No.: US 2006/0029121 A1
(43) Pub. Date: Feb. 9, 2006

(54) Test apparatus and test method for the nondestructive testing in particular of membrane electrode assemblies for use in fuel cells, which can be integrated in production

(75) Inventors: Mathias Boehmisch, Singen (DE); Cornelius Haas, Daisendorf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/192,458

(22) Filed: Jul. 28, 2005

(30) Foreign Application Priority Data
Aug. 3, 2004 (DE) 10 2004 037 575.5

(51) Int. Cl. G01N 25/00

(52) U.S. Cl. 374/45

(57) ABSTRACT

A test apparatus (1) is provided for finding and locating defects in a workpiece (5, 6) The apparatus (1) has at least one heat source (2, 7, 13, 14), at least one sensor apparatus (3, 10, 11, 12) for determining the temperature distribution on at least one surface (8) of the workpiece (5,6), and an evaluation apparatus (4) connected to the sensor apparatus (3, 10, 11, 12) in which apparatus the workpiece (5, 6) and the test apparatus (1) are arranged such that they can move relative to one another in a direction (R) parallel to the surface (8) which has been exposed to the heat. The sensor apparatus (3, 10, 11, 12) extends at least along a line which is transverse with respect to the direction (R) of relative movement downstream of the heat source (2, 7, 13, 14) as seen in the direction (R) of relative movement, in order to measure the temperature distribution along at least this line. A test method for finding and locating a defect by means of a test apparatus of this type is also provided.

Priority is claimed to German Application Serial No. 10 2004 037 575.5, filed Aug. 3, 2004, the entire disclosure of which is incorporated by reference herein.

### FIELD OF THE INVENTION

The invention relates to a test apparatus for finding and locating defects in a workpiece and to a test method for the same.

### BACKGROUND

Increasing demands on quality and reliability of workpieces and the objects formed from them require ever better test apparatuses and test methods for recognizing flaws or damage in the workpieces. One object in this context is for at least all the workpieces, which are used in areas in which failure of the workpiece would lead to direct or indirect serious harm to a person, to be subjected to nondestructive testing as soon as possible after they have been produced. These areas include, for example, power engineering, automotive engineering, aeronautical and aerospatial engineering.

Known test methods and test apparatuses are based, for example, on transillumination by means of X-radiation, or by means of ultrasound or on observation of the workpiece in the infrared region, in the region which is visible to the human eye or in the ultraviolet region. Not every test method can be used for every material.

Particular difficulties arise when testing workpieces consisting of a plurality of joined layers of different materials for defects, in particular in membrane electrode assemblies, or MEAs for short, for fuel cells. Defects in MEAs may, for example, be porous areas, cracks running through one or more layers, incomplete lamination between adjacent layers, delamination, bubbles, missing material or a layer which is missing in some locations, fluctuations in the thickness of one or more layers or their joining regions, positioning errors between individual layers, overlaps, creases and the like. The structure of an MEA is explained by way of example in DE 102 004 019 475.0. MEAs are produced in a continuous production process, in which the respective constituents of the individual layers of the MEA are supplied continuously in roll form and laminated to one another, so that the MEA is also discharged from the production process continuously as an endless product before being cut into pieces for installation in fuel cells in a subsequent further processing step. In this context, it would be particularly desirable for the continuous production process to be monitored in line and in real time by immediate quality control during or immediately after production of the MEA, in order for defects and their causes, for example a crease entering the lamination operation or the like in a layer of the MEA which could destroy the whole production run, to be recognized as quickly as possible and in order, if appropriate, to allow countermeasures to be taken while the production process is still running. However, automatic monitoring of the MEA which emerges from the laminating apparatus after the lamination step is difficult because the MEA has a surface which in optical terms is a deep shade of black, making it impossible to use cameras or the like operating in the visible region for quality control and recognition of defects in the MEA. Furthermore, the MEAs comprise a plurality of layers which are arranged plane-parallel, are joined to one another and the materials properties of which do not permit inspection by means of X-radiation or ultrasound. It is therefore aimed to carry out tests and quality inspections on MEAs by means of observations and measurements in the infrared region, in particular by measuring the temperature distribution on one or more surfaces of the workpiece. Suitable measures generate temperature differences with respect to the surroundings at defects, and these temperature differences can be discovered by means of sensor apparatuses which are suitable for observation and measurement in the infrared region. In this context, the term temperature distribution is to be understood as meaning a multiplicity of individual temperatures which can, in each case, be assigned to the finite surface elements at the workpiece surface.

It is proposed in DE 102 004 019 475.0 to find electrical defects in an MEA by thermography by applying a voltage between anode and cathode of the MEA, with a short circuit being formed and heat released at an electrical defect in the MEA. The temperature difference at the defect compared to the surrounding surface can be determined by observation in the infrared region and in this way the defect can be located. A drawback in this arrangement and the associated method is that it is only possible to find electrical defects. Furthermore, it is impossible to make any statements as to the position of the defect over the depth of the workpiece, and also there is a risk of an intact workpiece being completely destroyed if the voltage selected is too high.

U.S. Pat. No. 6,517,238 B2 has disclosed a method for finding cracks running perpendicular to a surface of a workpiece, in which part of a surface of the workpiece which runs normally with respect to the crack is briefly heated, and it is then observed at this surface of the workpiece or at a surface of the workpiece running parallel to the heated surface, how the heat propagates parallel to the surface. A crack running perpendicular to the heated surface disturbs the conduction of heat in the workpiece, with the result that it is possible to observe a deviation from an ideal temperature gradient which can be determined experimentally or theoretically, from the heated part of the surface to the unheated part, and from this information it is possible to infer the position of the crack and its extent in the direction normal to the heated surface. A drawback of this method is that it cannot be used for quality control of workpieces produced in a continuous process, either during or after the production process. Furthermore, it is impossible to make any statements concerning cracks running parallel to the heated surface, bubbles, overlaps and the like.

U.S. Pat. No. 5,711,603 has disclosed a method for finding cracks running parallel to a surface of a workpiece, in which a surface running parallel to the crack is briefly heated and then the propagation of the heat in the direction normal to the heated surface in the workpiece is observed by measuring the temperature distribution on the surface which has previously been heated or a surface which is opposite and parallel to this surface. A defect, for example in the form of a crack or a bubble, by inhibiting the conduction of heat in the workpiece, produces a temperature increase or drop, which is detectable at the surface, compared to the surrounding regions at the surface, depending on the side of the workpiece on which the temperature measurement takes place relative to the heated surface. The depth of the defect below the heated surface can be determined as a function of the time which has elapsed from heating to determination of a temperature difference.

A drawback of this method is that a relatively long period of time is required to carry out the method, during which time the whole of the workpiece is exposed to different method steps at the same time, so that its use for quality control following a continuous production process or at least a production process which involves continuous cycles, for example, at intervals of seconds, is not possible or is only possible by permanently interrupting the production process.

DE 697 04 571 T2 has disclosed a method and an apparatus for finding and locating porous areas in an MEA, in which a different gas is applied to each of the two sides of the MEA, with the two gases reacting exothermically with one another if they come into contact, so that porous areas can be located by tracking the heat which is released exothermically. One drawback of this method is that it is only possible to detect defects which produce a connection between the two sides of the MEA. Furthermore, the method, which is dangerous on account of the fact that gases which chemically react exothermically with one another are being used, on account of the complex and time-consuming preparation required, is unsuitable for use with continuously produced workpieces immediately after the production process used for these workpieces.

DE 101 50 633 A1 has disclosed a method and an apparatus for controlling the quality of welded joins, in which a welded join is briefly heated at its surface in order that conclusions can then be drawn as to the quality, homogeneity and welding lens diameter, by observing the time profile of the temperature distribution at the surface of the welded join, which is a measure of the dissipation or transfer of heat. One drawback of this method is the discontinuous operation, in which first of all the whole of the welded join has to be heated, and then the time profile of the temperature distribution of the surface has to be observed, which means that it cannot be used for quality control and testing of workpieces produced in a continuous production process following or during this production process.

### SUMMARY OF THE INVENTION

It is therefore an object of the present invention to provide a test apparatus and test method with which it is possible to find and locate as many different types of defect as possible in a workpiece, in particular an MEA, during or immediately after the continuous process of producing the workpiece.

In accordance with an embodiment of the present invention, a test apparatus is provided for finding and locating defects in a workpiece. The apparatus includes at least one heat source, at least one sensor, and an evaluation apparatus. The at least one sensor is arranged to determine a temperature distribution on at least one surface of the workpiece. The evaluation apparatus is connected to the at least one sensor. The workpiece and the test apparatus are movable relative to one another in a direction (R) parallel to the at least one surface. The sensor extends at least along a line which is transverse with respect to the direction (R), and which is downstream of the heat source in the direction (R), such that the sensor can measure the temperature distribution at least along said line.

In accordance with another embodiment of the present invention, a test method for finding and locating defects in a workpiece is provided. In this regard, the work piece is of the type that when a surface of the workpiece undergoes a brief, uniform change in temperature as a result of a heat flow (\dot{Q}), and the change in the temperature distribution over the course of time on this surface or a parallel, opposite surface is observed, it is possible to recognize a defect in the workpiece as a result of an inhomogeneous temperature distribution which subsequently occurs at the surface. The method comprises the steps of applying a heat flow (\dot{Q}) which is constant over a course of time to a surface of the workpiece in a cross section taken perpendicular to said surface, continuously moving the workpiece in a direction (R) perpendicular to this cross section (9) and parallel to the surface (8) which is exposed to the heat flow (\dot{Q}), and continuously measuring a temperature distribution at at least one surface of the workpiece (5, 6) along at least one line which is transverse with respect to the direction (R). The measured temperatures are transmitted to an evaluation apparatus. Temperatures are compared which are (i) measured simultaneously at adjacent locations on the surface of the workpiece along a line which is transverse with respect to the direction (R) of movement; and/or measured successively at adjacent locations on the surface of the workpiece along a line which is parallel to the direction (R) of movement. A defect is recognizable on the basis of a deviation between the temperatures measured at at least two adjacent locations, and if a defect is recognized, a signal is emitted which indicates that a defect has been found.

Such a test apparatus and/or method has an advantage over the prior art in that the workpiece and the test apparatus are arranged such that they can move relative to one another in a direction parallel to the surface which has been exposed to the heat, in order for the measurement to be carried out. In accordance with an embodiment of the present invention, the sensor apparatus, which works in the infrared region, extends at least along a line which is transverse with respect to the direction of relative movement, downstream of the heat source as seen in the direction of relative movement, in order to measure the temperature distribution along at least this line, which covers a region which is only very narrow in the direction of relative movement but takes up at least part of the width of the workpiece in the direction transverse to the direction of relative movement, in real time. The temperatures, which are measured continuously for each location along the line, are continuously compared, in the evaluation apparatus connected to the sensor apparatus, with the temperatures which are simultaneously measured at adjacent locations along the line, once again in real time. It is equally possible for the temperatures which are measured in succession at adjacent locations in the direction of relative movement to be compared with one another, or for the two possibilities to be combined. In this context, the term location is to be understood as meaning not a mathematical point, but rather a finite surface element at the surface of the workpiece. The term continuously includes a multiplicity of individual measurements or interrogations which immediately follow one another, in particular by means of an electronic data processing apparatus. On account of the relative movement between test apparatus and workpiece, therefore, temperature can be applied to the whole of the workpiece and the whole of the workpiece measured, after observation for a certain period of time during which the workpiece is moving past the test apparatus. If a temperature difference is recognized between adjacent locations, indicating the presence of a defect, the evaluation apparatus can assign the defect to a position in the workpiece. The heat source is in this case designed, for example, as a heated roller which touches the workpiece and extends over at least part of the width of the latter so that that surface of the workpiece, moving relative to the roller, which faces the heat source is briefly heated in linear fashion as it rolls over the roller. As an alternative to heat being applied through heat conduction by means of a roller, it is also conceivable for the heat source to be designed as a radiation source or as a hot-gas or warm-gas blower. Moreover, it is conceivable to use a heat sink which cools the surface of the workpiece rather than a heat source. The sensor apparatus may, in this case, for example, be an infrared camera, a line detector or a point detector or a combination of one or more such detectors which, by way of example, are connected to form a sensor array which is arranged over an area or along a line.

An advantageous configuration of the test apparatus according to the invention provides for the sensor apparatus to take up a region which extends in the direction of the relative movement and also, at least over part of the width of the workpiece, transversely to the direction of relative movement. In this case, the length of the region in the direction of relative movement is selected in such a way that an inhomogeneous temperature distribution, indicating a defect in the workpiece, occurs within the region taken up by the sensor apparatus, irrespective of the depth of the defect below the surface exposed to heat; the cross section, corresponding to the line transverse with respect to the direction of relative movement, in which the inhomogeneous temperature distribution is recognized by the sensor apparatus can be assigned to a specific depth of the defect in the workpiece, on the basis of the time which has elapsed since the introduction of heat owing to the continuous relative movement of the workpiece from the heat source to the region occupied by the sensor apparatus, so that the defect can be located in three dimensions, i.e. both in area and in depth. By determining the position of the defect in the depth of the workpiece, it is possible, in particular in the case of workpieces which are of a multilayer structure, such as for example the MEA of a fuel cell, to identify the layer, and therefore the subcomponent, or the interface between adjacent layers, at which the flaw causing the defect is located, so that if appropriate, conclusions can be drawn as to errors in the production method or production process, and these errors can be eliminated as appropriate.

An advantageous configuration of the test apparatus according to the invention provides that the heat source and the sensor apparatus are arranged spaced apart from one another at a settable spacing in the direction of relative movement. The spacing between heat source and sensor apparatus can be altered, for example, as a function of the workpiece, for example its structure, thickness and materials properties, in particular its specific heat capacity, and/or the relative velocity and/or heat flow from the heat source into the workpiece and/or the arrangement of the sensor apparatus and/or of the heat source relative to the workpiece. By way of example, it may be crucial for the spacing between heat source and sensor apparatus whether the sensor apparatus is arranged on the same side of the workpiece as the side on which the heat is introduced (for example by means of radiation, heat conduction or heat transfer), in which context, by way of example, temperature and heat capacity of the heat source or of the auxiliary substance, for example a heated gas, and the flow velocity of the latter may have an influence on the spacing.

An advantageous configuration of the test apparatus according to the invention provides for the sensor apparatus and the heat source to be arranged on opposite sides of the workpiece, separated from one another by the workpiece.

Another advantageous configuration of the test apparatus according to the invention provides for the sensor apparatus and the heat source to be arranged on the same side of the workpiece.

According to another advantageous configuration of the test apparatus according to the invention, at least one sensor apparatus is arranged on the side of the workpiece which is remote from the heat source, and at least one sensor apparatus is arranged on the side of the workpiece which faces the heat source.

An additional, advantageous configuration of the test apparatus according to the invention includes a position-recognition apparatus connected to the evaluation apparatus, for example an incremental transmitter, for determining the distance covered by a defect which has been located in the workpiece since it was located relative to a reference point of the test apparatus.

A particularly advantageous configuration of the test apparatus according to the invention includes a marking apparatus, which can be controlled by the evaluation apparatus, for marking a defect which has been located on the workpiece surface.

Another particularly advantageous configuration of the test apparatus according to the invention includes a cutting apparatus, which can be controlled by the evaluation apparatus, for automatically cutting a defect which has been located out of the workpiece or for cutting out a section which includes the defect and extends over the width of the workpiece transversely with respect to the direction of relative movement.

An additional, particularly advantageous configuration of the test apparatus according to the invention provides for the workpiece to be produced in a process that is continuous at least at times, the test apparatus being arranged following a production apparatus which produces the workpiece continuously at least at times, at the exit of the endless workpiece from the production apparatus, for in-line quality control.

According to another embodiment of the present invention, a test method is provided which includes the method steps of:
application of a heat flow, which is constant over the course of time and effects a uniform temperature change at a surface of the workpiece, to a surface of the workpiece in a cross section, which takes up at least part of the width of the workpiece, perpendicular to this surface,
continuous relative movement of the workpiece in a direction perpendicular to this cross section in which the heat flow is applied to its surface and parallel to the surface exposed to the heat flow,
continuous measurement of the temperature distribution on at least one surface of the workpiece along at least one line which is transverse with respect to the direction of relative movement between workpiece and heat source downstream, as seen in the direction of relative movement, of the cross section in which the heat flow is applied,
transmission of the measured temperatures to an evaluation apparatus in real time,
comparison of temperatures which are measured simultaneously at adjacent locations on the surface of the workpiece along a line which is transverse with respect to the direction of relative movement and/or
comparison of temperatures measured successively at adjacent locations on the surface of the workpiece along a line which is parallel to the direction of relative movement,
recognition of a defect on the basis of a deviation between the temperatures measured at at least two adjacent locations, and
if a defect is recognized, emission of a signal which indicates that a defect has been found in real time.

The heat flow may have a positive or negative sign, i.e., may increase or reduce the temperature at the workpiece surface. The heat flow acts at least on that part of the width of the workpiece over which a subsequent temperature measurement, which is carried out in the direction of relative movement after the action of the heat flow, takes place. The signal may in this case be a warning sound, a warning light, a text message on an output apparatus or the like or may take the form of an intervention in the production process.

A test method of this type is not restricted solely to use in combination with MEAs or sub-components thereof, but rather can also be used to test other components of a fuel cell, for example the bipolar plate, or in other technical fields, for example to test the coating of automobile body parts, to test adhesive bonds, to test fiber composite components, to test painting, to test multilayer components, for example shaped wood-glue joins, and the like.

An advantageous configuration of the test method according to the invention includes the additional method step of:
measurement of the temperature distribution within a region which extends in the direction of relative movement and, at least over part of the width of the workpiece, transversely with respect to the direction of relative movement.

In this case, a defined period of time since the action of the heat flow on the surface of the workpiece after passing the cross section in which the heat flow has acted on this part of the surface, can be assigned to the line which runs transversely with respect to the direction of relative movement, is located within the region in which the temperature measurement takes place and along which an inhomogeneous temperature distribution can be determined. This period of time is in turn a measure of the position of the defect in the depth of the workpiece below the location at which the inhomogeneity appears at the surface of the workpiece.

Another advantageous configuration of the test method according to the invention includes one or more of the following additional method steps:
continuous feeding of a workpiece, which is produced in a continuous production process, to the cross section in which the heat flow is applied and to the measurement of the temperature distribution in line following the production process,
recognition of a defect on the basis of a deviation in the temperature at a location on the surface of the workpiece from a setpoint value,
automatic marking of a defect which has been located on a surface of the workpiece,
automatic cutting of a defect which has been located or of a section which includes the defect out of the workpiece,
classification of the defect on the basis of its position in the area and/or depth of the workpiece,
storage and/or outputting of the class of the defect,
outputting of the location at which the defect was found in the workpiece in two-dimensional or three-dimensional coordinates.

Classification of the defects can be carried out, for example, on the basis of the position of the defect in the depth of the workpiece, accordingly in a defined layer of the MEA or at a joining location between adjacent layers and/or on the basis of the dimensions of the defect and/or its position in the area, for example at the edge or in the center, in the sealing region or the port region with a differing structure or strength of the MEA.

### BRIEF DESCRIPTION OF THE DRAWINGS

The invention is explained in more detail below with reference to drawings, in which:

FIG. 1 shows a side view of a test apparatus according to an embodiment of the present invention,

FIG. 2 shows a plan view of the test apparatus of FIG. 1, and

FIG. 3 shows a side view of three different variants A, B and C of the arrangement of heat source and sensor apparatus in a test apparatus according to embodiments of the present invention.

### DETAILED DESCRIPTION

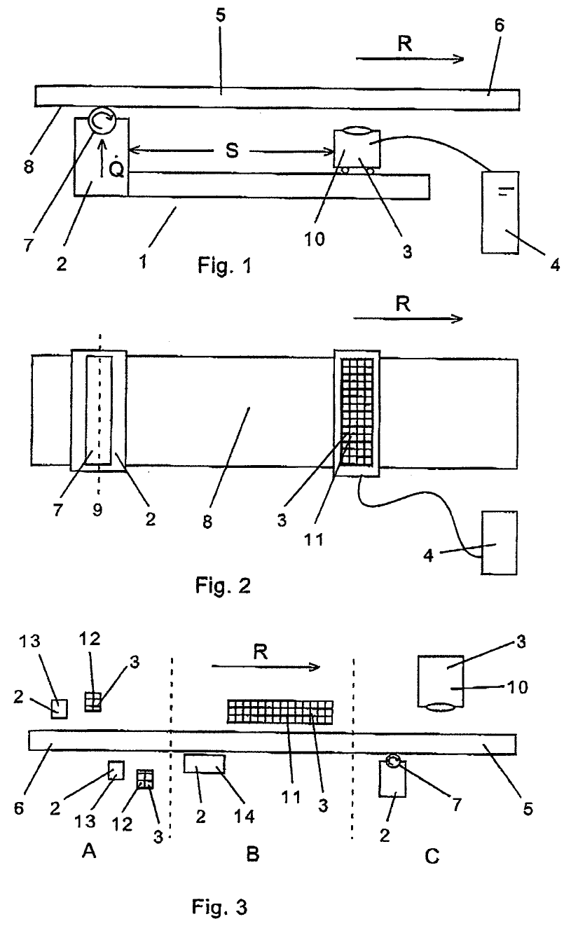

The test apparatus 1 shown in FIG. 1 comprises a heat source 2, a sensor apparatus 3 which works in the infrared region, and an evaluation apparatus 4, which is connected to the sensor apparatus and is arranged such that it can move relative to a workpiece 5 in direction R of relative movement. The workpiece 5 is a membrane electrode assembly 6, which is produced by plane-parallel lamination of a plurality of layers to one another in a continuous production process, downstream of which the test apparatus 1 is arranged so that the MEA 6 moves past the heat source 2 and the sensor apparatus 3 continuously in direction R of relative movement. The heat source 2 has a roller 7, which is arranged such that it can rotate transversely with respect to the direction of relative movement and over which the MEA 6 rolls, so that the roller 7 and the MEA 6 are in contact with one another. In the process, the heat source 2 transfers the constant heat flow \dot{Q} to the surface 8 of the workpiece 2, so that the workpiece is briefly heated or cooled at its surface 8, depending on the sign of the heat flow \dot{Q}, over its entire width transversely with respect to the direction R of relative movement, along the contact line 9 with the roller 7 to a temperature which is constant along the contact line 9. Until a location on the surface 8 of the workpiece 5 which has previously been heated by the roller 7 passes the sensor apparatus 3, the heat propagates through the workpiece 5 in accordance with heat conduction laws, but defects in the workpiece 5, in particular in the multilayer MEA 6, impede or inhibit the conduction of heat in the workpiece 5, so that a different temperature, an elevated temperature in the case of heating of the roller 7, can be measured at a defect on the surface 8 that has previously been heated compared to the adjacent locations in the direction which is transverse with respect to the direction R of relative movement. To measure this temperature distribution at the surface 8, the sensor apparatus 3 is designed as an infrared camera 10, a sensor array 11 or as spot detectors 12 arranged along a line which is transverse with respect to the direction of relative movement. The sensor apparatus 3 transmits the measured temperature distribution to the evaluation apparatus 4, which is designed as a computer and finds and locates defects in the workpiece 5 in real time on the basis of temperature differences between locations which were heated simultaneously as they pass the sensor apparatus 3. The sensor apparatus 3 is in this case at a defined but adjustable spacing S with respect to the heat source 2. By changing the spacing S, the heat flow \dot{Q} and the speed of relative movement, it is possible to adapt the test apparatus 1 to the properties, geometry and structure of the workpiece. The purpose of the heat source 2 in this context is to locally or areally heat the workpiece 5 for a brief period of time. The workpiece should not be heated “isothermally” up to a constant equilibrium temperature, but rather should merely undergo an increase in temperature at its surface 8, with this increase in temperature then, on account of the equilibrium condition, through heat conduction in the workpiece 5, initiating a dynamic process in which the heat propagates through the workpiece 5, in particular into its depth. All processes which are known from thermodynamics, such as radiation, heat conduction and heat transfer, are suitable for transferring the heat flow \dot{Q}. It is not necessarily imperative that the workpiece 5 be heated, but rather it is also possible for it to be cooled.

FIG. 2 shows the contact line 9 along which the roller 7 briefly heats the workpiece 5 at its surface 8. The sensor apparatus is in this case designed as a sensor array 11.

In FIG. 3, in region A infrared radiators 13 as heat source 2 and a plurality of spot detectors 12, which are arranged in a row along a line running transversely with respect to the direction R of relative movement, are arranged on both sides of the workpiece 5, offset with respect to one another. In region B, a hot gas blower 14 as heat source 2 is arranged below the workpiece and a sensor array 11 for use as sensor apparatus 3 is arranged on the opposite side, separated by the workpiece 5. In region C, a roller 7 as heat source 2, is arranged below the workpiece, and an infrared camera 10 for measuring the temperature distribution at the surface 8 of the workpiece 5 is arranged above the workpiece 5. The heat sources 2 are always located upstream of the sensor apparatuses 3, as seen in the direction R of relative movement.

In principle, it is also conceivable for the test apparatus 1 to be used for inspection of incoming goods. In this case, the workpiece 5 can also be measured a number of times by being moved to and fro, so that the accuracy with which defects are found can be improved, for example, by a repetition measurement being initiated automatically by the evaluation apparatus 4 if the results are unclear. In addition, any desired combination of heat sources 2 and sensor apparatuses 3 is possible, for example by a plurality of components of the same type being arranged in succession in the direction R of relative movement. The development of the heat flux over the course of time can very easily be recorded by a plurality of detectors or sensors arranged in succession, which together form one or more sensor apparatuses without an expensive camera system having to be used. The evaluation, presentation and documentation of the defects is effected, for example, by an imaging process and is computer-aided. The data processing as a whole may be time- and/or event-controlled and generates a quantitative description of the events. Assessment can be carried out by comparison with a predetermined set of values. The feedback to the production process may be effected manually, in automated fashion on the basis of control variables, or even in self-learning form with the aid of suitable software. Furthermore, it is conceivable for a defect which has been recognized to be marked or cut out.

It is also conceivable for the test apparatus 1 to be combined with pulsed thermography, which is known from the prior art. In this context, by way of example, it is conceivable for the intensity of the heat flow \dot{Q} to be altered over the course of time or on a purely local basis.

The invention is capable of industrial application, in particular for the quality control and monitoring of the process for producing membrane electrode assemblies for fuel cells.

An example of a typical application of the test apparatus is the testing of fuel cell components, in particular of MEAs or BiPs, or of the sub-components thereof, such as for example their membranes. Use both in the production process and for incoming goods is conceivable.

What is claimed is:

1. A test apparatus for finding and locating defects in a workpiece comprising,
at least one heat source,
at least one sensor, the at least one sensor arranged to determine a temperature distribution on at least one surface of the workpiece, and
an evaluation apparatus connected to the at least one sensor,
wherein the workpiece and the test apparatus are movable relative to one another in a direction (R) parallel to the at least one surface, and
wherein the sensor extends at least along a line which is transverse with respect to the direction (R), and downstream of the heat source in the direction (R), such that the sensor can measure the temperature distribution at least along said line.

2. The test apparatus as claimed in claim 1, wherein the sensor extends over a region which extends in the direction (R) and, at least over part of a width of the workpiece, transversely with respect to the direction (R).

3. The test apparatus as claimed in claim 1, wherein the heat source and the sensor are arranged spaced apart from one another at a settable spacing (S) in the direction (R).

4. The test apparatus as claimed in claim 1 wherein the sensor and the heat source are arranged on opposite sides of the workpiece.

5. The test apparatus as claimed in claim 1 wherein the sensor and the heat source are arranged on t a same side of the workpiece.

6. The test apparatus as claimed in claim 1 wherein the at least one sensor includes at least two sensors, and wherein one of the sensors is arranged on a side of the workpiece which is remote from the heat source, and another of the sensors is arranged on a side of the workpiece which faces the heat source.

7. The test apparatus as claimed in claim 1, further comprising a position-recognition apparatus connected to the evaluation apparatus.

8. The test apparatus as claimed in claim 7, further comprising a marking apparatus, which can be controlled by the evaluation apparatus, the marking apparatus arranged to mark a defect which has been located on the workpiece surface.

9. The test apparatus as claimed in claim 7, further comprising a cutting apparatus, which can be controlled by the evaluation apparatus, the cutting apparatus arranged to automatically cut a defect which has been located out of the workpiece or to cut out a section which includes the defect and extends over the width of the workpiece transversely with respect to the direction (R).

10. The test apparatus as claimed claim 1, wherein the workpiece is produced in a process that is continuous at least at times, and wherein the test apparatus is arranged following a production apparatus which produces the workpiece continuously.

11. A test method for finding and locating defects in a workpiece, in which a surface of the workpiece undergoes a brief, uniform change in temperature as a result of a heat flow (\dot{Q}), and by observing the change in the temperature distribution over the course of time on this surface or a parallel, opposite surface, it is possible to recognize a defect in the workpiece as a result of an inhomogeneous temperature distribution which subsequently occurs at the surface, which method comprises the steps of
applying a heat flow (\dot{Q}) which is constant over a course of time to a surface of the workpiece in a cross section taken perpendicular to said surface;
continuously moving the workpiece in a direction (R) perpendicular to the cross section and parallel to the surface which is exposed to the heat flow (\dot{Q});
continuously measuring a temperature distribution at at least one surface of the workpiece along at least one line which is transverse with respect to the direction (R);
transmitting the measured temperatures to an evaluation apparatus,
comparing temperatures which are measured simultaneously at adjacent locations on the surface of the workpiece along a line which is transverse with respect to the direction (R) of movement and/or comparing temperatures measured successively at adjacent locations on the surface of the workpiece along a line which is parallel to the direction (R) of movement,
recognizing a defect on the basis of a deviation between the temperatures measured at at least two adjacent locations, and
if a defect is recognized, emitting a signal which indicates that a defect has been found.

12. The test method as claimed in claim 11, further comprising the step of:
measuring a temperature distribution within a region which extends in the direction (R) of relative movement and, at least over part of the width of the workpiece, transversely with respect to the direction (R) of relative movement.

13. The test method as claimed in claim 11, further comprising the steps of:
continuously feeding the workpiece, which is produced in a continuous production process, to a cross section in which the heat flow (\dot{Q}) is applied and to a cross section in which the temperature distribution is measured,
recognizing a defect on the basis of a deviation in the temperature at a location on the surface of the workpiece from a setpoint value,
automatically marking a defect which has been located on a surface of the workpiece,
automatically cutting a defect which has been located or of a section which includes the defect out of the workpiece,
classifying the defect on the basis of its position in the area and/or depth of the workpiece,
storing and/or outputting the class of the defect,
outputting the location at which the defect was found in the workpiece in two-dimensional or three-dimensional coordinates.
